(19) United States
(12) Patent Application Publication
(10) Pub. No.: US 2003/0074389 A1
(43) Pub. Date: Apr. 17, 2003

(54) Scheme for dynamic process network reconfiguration

(76) Inventors: I-Chih Kang, Eindhoven (NL); Albert Van Der Werf, Eindhoven (NL); Kees Gerard Willem Goossens, Eindhoven (NL)

Correspondence Address: U.S. Philips Corporation, 580 White Plains Road, Tarrytown, NY, 10591, US

(21) Appl. No.: 10/266,299

(22) Filed: Oct. 8, 2002

(30) Foreign Application Priority Data
Oct. 12, 2001 (EP) 01203905.3

(51) Int. Cl. G06F 9/00

(52) U.S. Cl. 709/106

(57) ABSTRACT

Streaming applications can be represented by process networks (562), in which tasks (450, 451, 456) perform processing of data and communicate these data to each other through FIFO channels (455). During steady-state processing, the process network (562) is fixed (fixed number of tasks (450, 451, 456) and channels (455)). However, the functionality of the application may be changed at run-time implying a different process network topology. In order to avoid the run-time overhead of destroying the entire network (562) and then set up a new one, the network (562) should be dynamically reconfigured. A central task (454) manages the network topology and can issue commands to stop or suspends tasks (450, 451, 456), remove or redirect channels (455), etc. In order to avoid artefacts (e.g. processing display incomplete video frames), the tasks (450, 451, 456) respond to these commands only at certain reconfiguration points (101, 102, 103, 104) in their processing loop. By the designer these points (101, 102, 103, 104) can be freely chosen, taking into consideration the reconfiguration latency, possible partial data handling, and state cleaning.

### FIELD OF THE INVENTION

The present invention relates to a method for dynamic process network reconfiguration, the process network comprising a streaming application represented by a process network in which a first task processes data and the first task communicates data to a second task through a communication channel. The present invention further relates to an apparatus with means for dynamic process network reconfiguration, the process network comprising a streaming application represented by a process network in which a first task processes data and the first task communicates data to a second task through a communication channel.

In complex systems that support different function modes, a mechanism is needed for seamless switching between these function modes. Signal processing applications are often modelled as process networks therefore functional switching implies reconfiguration of these networks. Signal processing applications are therefore considered to be a field of use for the invention. For example, the invention can be used in video applications, where the video applications may comprise tasks like enhancement, decoding etc.

### BACKGROUND OF THE INVENTION

In the proceedings of the IFIP Congress 74, Gilles Kahn has published the article: The Semantics of a Simple Language for Parallel Programming. The article describes a simple language for parallel programming. The language semantics is studied thoroughly. The desirable properties of the language and its deficiencies are exhibited by a theoretical study. Basic results on parallel program schemata are given. The described programming model is often referred to as Kahn process networks.

In the International Symposium on Circuits and Systems (ISCAS) 2001, K. G. W. Goossens has published the article: A Memory Manager for On-chip Communication. This article describes a protocol for on-chip data communication, in which a central memory manager handles the synchronization between tasks. Furthermore, the individual tasks can autonomously indicate willingness to start/stop their operation. This protocol allows reconfiguration of process networks. The described protocol is referred to as the Arachne protocol.

From patent application number WO 99/22296 a method and system for synchronizing block-organized data transfer is known. With respect to a particular facility semaphore-based synchronizing is executed among a first station and one or more second stations. For each station a single bivalent semaphore is provided. The first station checks all second station semaphores as having a second state relative to its own semaphore's first state. It then executes a first accessing operation and flips the first state. Otherwise it foregoes the first accessing operation. Any second station checks the first station semaphore as having the second state relative to its own semaphore's second state. It then executes a second accessing operation and flips the latter state. Otherwise it foregoes the second accessing operation. This method can be used to synchronize data communication through channels between different tasks in a process network.

A number of alternative, “light weight” forms of reconfiguration can be realized using the original implementation. Passing processing parameters (e.g. filter coefficients) at run-time can be done in two ways:

Via explicit channels. The task periodically checks this channel for new parameters and accepts the new parameters. Depending on the task, this can be done blocking (must receive new parameters), or non-blocking (only use new parameters if there are any in the channel).

Attach to data stream. This can be done, by adding a header field in front of each data packet. Only the target task of this header information can interpret this field, it is transparent to the other tasks along the stream.

The advantage of the first option is that each task only receives parameters, which it needs, without the overhead of parsing parameters for other tasks in the stream. Furthermore, the same parameter only has to be sent once, if the target task knows to use that parameter from the moment of reception onwards. Only further changes in the parameters are communicated. The major disadvantage of this separation of data and parameters is that the synchronization between them becomes difficult. In the second option, the parameters are automatically synchronized with the data stream. The disadvantage is that parameters for all tasks are included in the stream, and that each task also receives parameters for other tasks. This results in some communication overhead. Rerouting a data stream can be done in a way other than rerouting a physical channel. The alternative is to set up all channels, and define a special task that routes the data stream. For instance, depending on some control parameter, this task can direct the incoming data to one of two consumers, the other consumer will eventually block due to the lack of data. In this way, the rerouting can be done very fast, without halting the tasks and changing the task and channel structure. The disadvantage is that all channels have been created but some of them are not used (inefficient memory utilization). Moreover, a separate task has to be dedicated to this limited functionality, which is a considerable overhead in terms of power and silicon area (if executed on a hardware device). Note that this task may also be reused to handle multi-casting with only a minor adjustment, in which case this overhead is reduced. The same concept as described above can also be used for adding or removing some functionality in a processing pipeline of tasks. For example, when switching to a lower bit-rate recording mode, an additional filter is needed to avoid losing too much quality. Instead of dynamically creating and starting this filter-task and inserting it in the pipeline, this task could already be active, and, depending on a control parameter, either just parses the incoming data, or performs the filter operation on the data. In another option, a task simply reroutes the data stream to the filter and back before parsing the filtered data to the next task. In this way, the tasks on each side of the filter do not have to be halted, which decreases the reconfiguration latency. The first option is more efficient than the other, since fewer tasks and channels are needed, and switching the functionality on or off can be done easily.

The “light weight” modes of reconfiguration as described above can be realized using the current implementation. The latency of such a network reconfiguration can be lower than having to halt tasks and then physically reroute the channels, this at the cost of higher memory usage in the form of extra task and channel structures. However, in a complex system in which there may be many tasks and channels, and which may have many function modes, these approaches will have a considerable memory overhead. Furthermore, these methods are limited to very simple network changes, and are not flexible enough to handle a complete network overhaul.

### SUMMARY OF THE INVENTION

An object of the present invention is to provide a dynamically reconfigured parallel processing network, which is robust, predictable, and reliable to any change in network topology.

To achieve this object, the method according to the preamble is characterized in that the process network is dynamically reconfigured, and a central task manages a process network topology, and said central task issues a command to manage the communication channel, and said central task issues a command to manage at least one task of the first and second task, and the at least one of the first and second task responds to said command only at a certain reconfiguration point in the at least one of the first and second task's processing loop.

Hereby it is insured to have a dynamic network, where dynamic network changes resulting from network topology changes are adapted. This results in an efficient and fast network. By in due time to perform dynamic network reconfiguration the network intercommunication decreases, helping to prevent overload conditions. As a consequence, there will in general be a significant reduction in traffic by critical network topologies, and the network will not easily be slowed down. Furthermore, under normal conditions, rerouting can be done very fast. By selecting proper reconfiguration points, artefacts in video applications in example can be avoided. Also, the network provides for stopping and destroying tasks and channels when they are no longer needed, or at emergency situations. Optionally, the tasks can decide for themselves to stop. Finally, at emergency situations, run-time overhead resulting from a changed network topology will not destroy the entire network. The network is therefore generally robust, predictable, and reliable to all change in network topology.

The basic idea is to have a central task managing the network topology of process networks. The central task being able to issue commands to stop or suspends tasks, and to remove or redirect channels, etc. In order to avoid artefacts, the tasks respond to these commands only at certain reconfiguration points in their processing loop.

An embodiment of the method as disclosed in claim 2, has the advantages, that the tasks can communicate via a simple channel structure, where output data from a task are transmitted into one end of the channel, and received as input data by another task from the other end. This makes it possible for tasks to intercommunicate data without any further knowledge of each other.

An embodiment of the method as disclosed in claim 3, has the advantages, that during run-time, if a particular task is no longer needed in a function mode, the task is simply stopped. Also if a changed application functionality results in a process network topology that can lead to excessive run-time overhead with the risk of destroying the entire network, an emergency change of the network topology can be made to prevent this from happening. This is therefore an attractive approach for network reconfigurations that require a drastic change of the network topology.

An embodiment of the method as disclosed in claim 4, has the advantages, that no data are lost in the channels. No task or data clean up activities are required in memory after reconfiguration. This is therefore an attractive approach for network reconfigurations under normal (ordinary) conditions. The method is typically used when channels have to be dynamically reconfigured (e.g. increase/decrease capacity, switch to different a producer/consumer etc.).

An embodiment of the method as disclosed in claim 5, has the advantages, that the central task is equipped with a sufficient number of commands to manage the tasks under various conditions. This makes the task management very versatile. By the ability to stop tasks, the central task is able to manage tasks that are needed in certain function modes, or at emergency conditions. By the ability to suspend tasks, the central task is able to manage tasks under normal (ordinary) conditions. By the ability to remove tasks, the central task is able to free memory wasted on stopped tasks, so that other tasks or channels may use it.

An embodiment of the method as disclosed in claim 6, has the advantages, that the central task is equipped with a sufficient number of commands to manage the channels under various conditions. This makes the channel management very efficient. By the ability to remove channels, the central task is able to free memory wasted on channels associated with stopped or suspended consumer and producer tasks, so that other tasks or channels may use it. By the ability to redirect channels, the central task is able to manage channels under normal (ordinary) conditions, as well as under conditions where the network is being reconfigured. By the ability to change channel properties, the central task is able to change memory characteristics, channel modes, i.e. in example if static or dynamic data block size are used, and channel synchronization methods, in example interrupt or polling. The ability to change the channel properties also includes changing the channel capacities. This implies modifying the number of and (possibly) the buffer pointer locations.

An embodiment of the method as disclosed in claim 7, has the advantages, that reconfiguration can be directed to the beginning (or the end) of iteration loops. For example, this infinite outer loop may correspond to frames, and the task can be reconfigured at the beginning of each frame. In this case, since for video applications the basic unit of display is a frame, the reconfiguration can take place without leading to artefacts visible to the user (such as partially displayed images).

An embodiment of the method as disclosed in claim 8, has the advantages, that reconfiguration can be directed to locations when trying to obtain a full buffer on an input channel. When the reconfiguration point coincides with a synchronization primitive, there will be no partially processed data left in the received packet at the time the task reconfigures. In this way, no data will be lost on the input channel. A packet is a data unit of synchronization (a memory block), as referred to in patent application number WO 99/22296.

An embodiment of the method as disclosed in claim 9, has the advantages, that reconfiguration can be directed to locations when trying to obtain an empty buffer on an output channel. When the reconfiguration point coincides with a synchronization primitive, there will be no partially processed data left in the sent packet at the time the task reconfigures. In this way, no data will be lost on the output channel. However, it may be lost inside the task itself if not careful. For instance, a task may have obtained a packet and has finished processing it, but then reaches a reconfiguration point before it can send its output, in which case the data is lost. This can be avoided by either relocating the reconfiguration point, or to first send the data before acknowledging the reconfiguration.

To further achieve the object, the apparatus according to the preamble is characterized in that the process network is dynamically reconfigured, and a central task manages a process network topology, and said central task issues a command to manage the communication channel, and said central task issues a command to manage at least one task of the first and second task, and the at least one of the first and second task responds to said command only at a certain reconfiguration point in the at least one of the first and second task's processing loop.

The same advantages as for an embodiment of the method disclosed in claim 1 apply for an embodiment of the apparatus as disclosed in claim 10.

These and other aspects of the invention will be apparent from and elucidated with reference to the embodiment(s) described hereinafter.

### BRIEF DESCRIPTION OF THE DRAWINGS

FIG. 1 shows a typical task code with possible reconfiguration points.

FIG. 2 shows dynamic and static channels.

FIG. 3 shows an overview of the device synchronization interface.

FIG. 4 shows a preferred embodiment of a re-configurable dynamic process network, which is also the best mode of the invention.

FIG. 5 shows a preferred embodiment of the invention implemented on a computer.

### DESCRIPTION OF THE PREFERRED EMBODIMENTS

Network reconfiguration includes the following actions:

Add new tasks or channels.

Remove tasks or channels.

Changing channels, this may include rerouting the channels or changing their capacity.

The CPU in the system is made responsible for managing the configurations and changing the network. This is a logical choice considering the following:

Many different network configurations are possible, and in the future more may be added. Performing network configuration in software allows for changes without modifications to the hardware. Furthermore, debugging is facilitated.

Network reconfiguration occurs relatively infrequently compared to data processing. Therefore it may be assumed that sufficient clock cycles are available for performing reconfiguration in software.

The hardware complexity should be minimized.

In practice, there will be a dedicated configuration management task running on the CPU. In order to perform reconfiguration, this task must have access to all control and status information. An architecture template that supports this is used, by means of a shared global address space, where a memory map defines the translation of addresses to local or global memory locations or hardware registers.

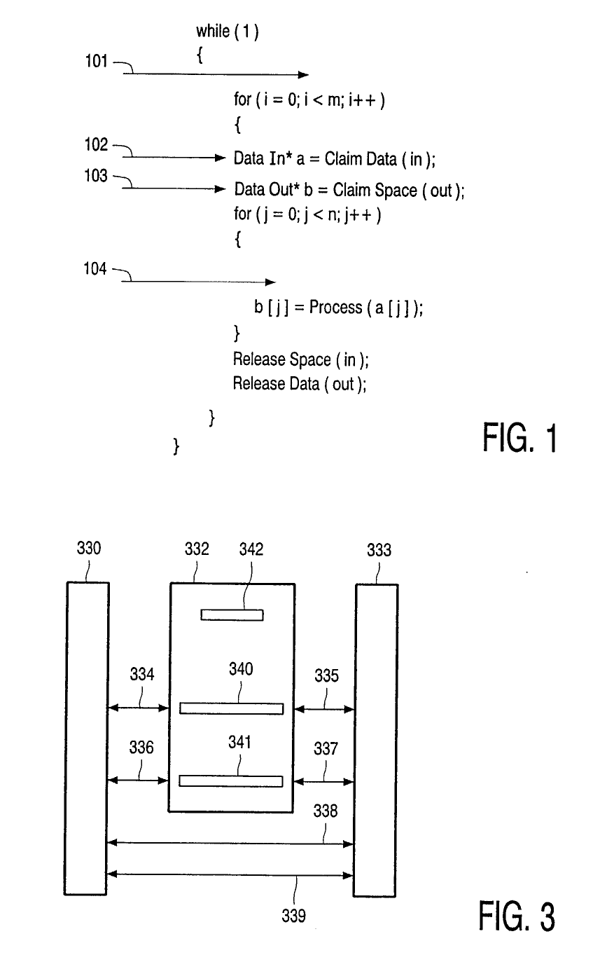

FIG. 1 illustrates a typical task code with possible reconfiguration points. Point 101 is a reconfiguration point at a boundary of an iteration loop. Point 102 is a reconfiguration point at a location when trying to obtain a full buffer on an input channel. Point 103 is a reconfiguration point at a location when trying to obtain an empty buffer on an output channel. Point 104 is a reconfiguration point within a processing loop.

During a task's operation, there may be different points at which, it is allowed to be reconfigured. Obviously, reconfiguration should not take place at any time, otherwise the network may become uncontrollable. A typical task loop is coded like shown in FIG. 1. Here, also the possible reconfiguration points are shown. These reconfiguration points are:

1. At the beginning, or possibly the end, of each iteration loop. For example, each loop iteration may be one video frame.

2. When trying to obtain a full buffer on an input channel.

3. When trying to obtain an empty buffer on an output channel.

4. Within the processing loop.

Reconfiguration point (1) corresponds to the beginning (or the end) of the outer iteration loop. For example, this infinite outer loop may correspond to frames, and the task can be reconfigured at the beginning of each frame. In this case, since for video applications the basic unit of display is a frame, the reconfiguration can take place without leading to artefacts visible to the user (such as partially displayed images). The disadvantage is that the reaction latency of the task to the reconfiguration command is potentially very long, in this case maximally one frame period.

When the reconfiguration point (2) and (3) coincides with a synchronization primitive, there will be no partially processed data left in the packet at the time the task reconfigures. In this way, no data will be lost. Note that the designer has some responsibility in taking care of this. For instance, a task may have obtained a packet and has finished processing it, but then reaches a reconfiguration point before it can send its output, in which case the data is lost. This can be avoided by either relocating the reconfiguration point, or to first send the data before acknowledging the reconfiguration.

The reconfiguration point (4) is located in the actual processing loop. Here it is assumed, that the data grain at which the processing is done is smaller than the synchronization grain, which means that processing is done on multiple samples within the data packet. In this case, the reconfiguration point can be reached at a relatively high frequency, depending on the data grain size that is most natural to the processing of the task (e.g. every macro block or DCT block). The advantage of this is that the task can quickly respond to the reconfiguration commands issued by the CPU, which is a positive thing if the network reconfiguration is time-critical. On the other hand, being able to reconfigure a task within a data packet also implies that there are partially processed data left at the moment of reconfiguration. It is up to the task itself to decide what to do in this situation: either to throw away the partial data (if the application allows it), or to neatly finish the entire packet and then clean up its state. Another disadvantage is that the overhead of checking for reconfiguration is too high, especially considering that reconfiguration occurs infrequently. Thus, it is questionable whether this reconfiguration point location is useful.

The optimal reconfiguration points are dependent on the application. Different applications have different requirements concerning reconfiguration latency, task state, etc. Therefore, this decision is left to the designer. He/she also has to be aware of the consequences of a particular decision and take care of any necessary actions to cope with them. These actions (e.g. freeing resources or executing necessary cleanup code) may be implemented in some kind of reconfiguration handler, which is task specific. The designer should also be extremely careful about the impact of the reconfiguration of a task (or a part of the network) on the rest of the processing pipeline. For instance, reconfiguring the input task may affect the processing of the rest of the network (e.g. different picture size). Determining at which point the other tasks should notice this change and how they should react to it is a crucial and difficult topic.

The first and most critical step in network reconfiguration is to halt the tasks, which are executing in steady state. By this is meant, that the task is repeatedly executing the cycle of reading data from input, processing the data, and writing data to output. Since the configuration manager does not exactly know the progress of each task (communicating this information back and forth would incur too much overhead), this is performed with a handshake protocol:

1. The configuration manager requests the selected task to halt its execution.

2. The task replies with an acknowledge once it has gone idle.

3. Upon receiving this acknowledge, the configuration manager moves on to the next task, or starts reconfiguring the task or the channels.

There are two options for receiving the acknowledge signal: 1) through polling of a status register, or 2) by using an interrupt. Polling is more efficient when the acknowledge of the task to be reconfigured is expected to arrive soon, since the overhead of interrupt handling is avoided. On the other hand, if the time between the reconfiguration request and acknowledge is long, then interrupts are more efficient because polling introduces a high busload. Two different possibilities for reconfiguring tasks are defined:

1. Reconfiguration with loss of state: tasks are completely stopped and their internal state (e.g. counters) is thrown away. They can be restarted later when needed. This is used for network reconfigurations that require a drastic change of the network topology, e.g. when switching from MPEG encoding to decoding mode.

2. Reconfiguration while preserving the state: tasks are suspended rather than stopped, while maintaining their state. This can typically be used when channels have to be dynamically reconfigured (e.g. increase/decrease capacity, switch to a different producer/consumer etc.). In this mode, no data is lost in the channels. The suspended tasks can be resumed afterwards.

For ‘static’ process networks, the tasks only have to be started, after which they can run autonomously and independently. Software tasks are started by making a operating system call. Hardware tasks are started, by sending a Task Start command to the processor shell. This wakes up the task from its initial idle state, where after it starts its execution. This same mechanism can be easily extended for reconfiguration by adding the following commands: Task Stop, Task Restart, Task Suspend and Task Resume. These commands are communicated as control parameters, i.e. outside the data channels. Another option is to communicate these commands via explicit channels. However, this requires setting up a channel for each task that is (dynamically) created, hence occupying more memory space. When a producer task has been stopped or suspended, the channel may be completely drained by the consumer task. This will cause the consumer task to block on its first next read action. If the configuration manager now issues a reconfiguration request to the consumer task and waits for an acknowledge, it will never receive it because the consumer task is blocked and hence can never reach a reconfiguration point and send that acknowledge. The system will be in deadlock. The reverse situation is also possible in which the consumer is first halted so the channel is completely filled by the producer, causing it to block on the next write, and the CPU tries to reconfigure the producer after this point.

To avoid this form of deadlock, a task should be notified when this kind of exception occurs, in which a blocked read/write action is caused by the task being reconfigured at the other side of the channel. Then the task can decide which action to take upon detection of this exception (at this point it is no longer blocked), such as to jump to a reconfiguration point immediately to check for the configuration manager's reconfiguration command. In any case, no buffer data or space will be claimed and the read or write operation is not completed.

When a task is in a stopped state, it can be removed if desired. This operation simply requires freeing the memory block containing the designated task record. This operation is only allowed when there are no more channels connected to this task, otherwise removing it may cause deadlock in the rest of the system. Furthermore, the application designer has to carefully take care of freeing system resources.

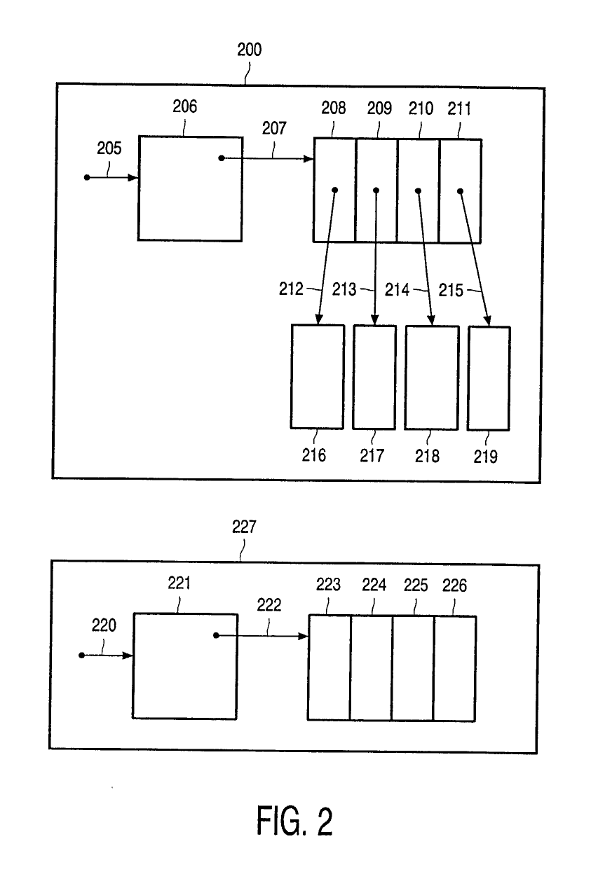

FIG. 2 illustrates a dynamic channel 200 and a static channel 227. 200 is a dynamic channel. 205 is a pointer. 206 is a buffer pointer area. 207 is a buffer pointer. 208, 209, 210 and 211 are data associated with tokens. 212, 213, 214 and 215 are pointers to data of various sizes 216, 217, 218 and 219 respective. 227 is a static channel. 220 is a pointer. 221 is a buffer pointer area. 222 is a buffer pointer. 223, 224, 225 and 226 are equal size data associated with tokens.

The following operations may be performed on the channel upon reconfiguration:

Remove a channel

Reroute a channel

Change the property of a channel

Change the capacity of a channel

Relocate the memory location of the FIFO

Removing a channel simply requires freeing the memory block containing the corresponding channel record. The buffer pointers associated with the channel are also removed. Furthermore, since the removal of a channel also affects its producer and consumer tasks, the records of these tasks must be updated first. This operation may be very expensive because of the many memory blocks that have to be freed (especially if the channel capacity is high). Removing a channel is only allowed when both its producer task and consumer task have been either stopped or suspended.

Channel rerouting operation consists of connecting the channel to a different producer or consumer, or both. This is done, by updating the producer and consumer task pointers in the corresponding channel record. Also, the channel must be removed from the records of the old tasks and added to the records of the new tasks. As for the change of channel mode, the channel support the following function modes:

Static/dynamic: in static channels, the data associated with each token are of equal size, and the buffers are allocated in one consecutive block in the global memory space. Whereas in dynamic channels, each token may be associated with various data sizes, and the individual buffers may reside in different parts (or even different physical memories). Dynamic channels, in fact, introduce an extra level of indirection and the tokens are initialised in a different way than static channels, see FIG. 2.

Interrupt/polling: when a task attempts to read an empty input channel or write a full output channel, it is blocked. When the channel is set to interrupt mode, then the task is unblocked, by sending it an interrupt. In polling mode, the blocked task repeatedly polls the status of the channel to see whether data has been written (in case of blocked read), or whether space has been freed (in case of blocked write). For hardware tasks, interrupt channels are more efficient because otherwise they introduce a high busload while polling the channel status. Software tasks, on the other hand, can best make use of polling channels, in order to avoid expensive operating system task switches and interrupt service routines.

Changing the channel mode can be done, by overwriting the mode flag field in the channel record. For dynamic channels, a piece of memory is allocated during creation that contains the channel buffers. This piece of memory must thus be freed when changing the channel to static. Conversely, when switching from static to dynamic mode, a piece of memory must be allocated. Switching this mode also necessitates re-initialisation of the channel buffer pointers. Switching from polling to interrupt mode and vice versa does not require any extra actions apart from updating the mode flag. Such a mode change can be useful e.g. when a channel is redirected from a hardware to a software task or vice versa.

Due to the different requirements of different application modes, it is desirable to be able to dynamically change the capacity of the channels. This implies modifying the number of and (possibly) the buffer pointer locations. Changing the capacity of a channel is done, by changing a field in the channel record. For static channels, the buffer pointers are updated when they are initialised again. The old ones can then be freed (separate action). For dynamic channels it is a little different due to the extra level of indirection. During creation, a piece of memory is allocated for storing a number of buffer pointers. The size of this memory must be changed when changing the channel capacity. This can be done, by calling the realloc function. The buffer pointers have to be reinitialised later. Note that in order to prevent losing data the channel must be emptied by the consumer before changing its capacity.

Sometimes it may be desirable to relocate the FIFO buffer to a different (part of the) memory, for instance, to keep the FIFO physically close to a processing device (local memory) so it can be accessed quickly. In order to avoid losing data, the content of the FIFO must be copied to its new location, or the channel must be emptied first before relocating the FIFO.

From the above descriptions, it can be seen that apart from rerouting, reconfiguration of a channel is very expensive due to the dynamic memory management that has to be carried out. It is better to statically allocate memory for all the channels that may be needed by the application in a set of known configurations and simply select between the available channels during reconfiguration, provided that no unforeseen new configurations can pop up during run-time. If the number of possible configurations is limited, the memory usage can be kept at a reasonable level. When taking this approach to the extreme the basic concepts of the Arachne architecture is found, as described in the article: A Memory Manager for On-chip Communication, ISCAS 2001. It is based on the notion of a large pool of tokens (or multiple pools), which is managed by a central token manager. Whenever a task wants to communicate, it requests a token from the token manager. Synchronization is performed at this level, since this request can be blocked. If a token is issued to the requesting task, it can use it to read/write the data associated with it. Keeping all knowledge of the channels and token pools centrally has the main advantage that the communication network can be kept very flexible. It is foreseen that all channel information is implemented in hardware so no memory management by the operating system is needed. Furthermore, changing the channel capacity simply involves allocating more or fewer tokens from the pool to that channel. The disadvantage of this centralized synchronization approach is that the architecture is less scalable.

A special configuration task is defined to handle the network management. Since it reconfiguration occurs infrequently, this task is inactive most of the time. At application start-up, it creates all the necessary tasks and channels corresponding to the initial function mode, it then suspends itself and waits for a trigger to perform the reconfiguration. This trigger may come from higher level application software requesting a different network topology because of a changed function mode, or from the processing tasks indicating that something has gone wrong and requiring emergency actions.

FIG. 3 illustrates an overview of the device interface with a hardware implementation. 330 is a communication network, for example a bus. 332 is a device/coprocessor shell. 333 is a device/coprocessor. 334 is a communication interface 1. 335 is a synch. interface 1. 336 is a communication interface 2. 337 is a synch. interface 2. 338 is a communication interface 3 (for data). 339 is a communication interface 4 (for data). 340 is a synch. block 1. 341 is a synch. block 2. 342 is a set of registers/a register bank for synchronization and reconfiguration.

A field has been added to the task record. This array can be used to pass up to four arguments to the task upon starting, restarting and resuming the task. A possible use is to pass dynamic channel IDs to the task.

As it earlier was stated that the tasks, which communicate with a task that is being reconfigured, should be notified of this, in order to prevent them from blocking on a get data/space forever as a result of the reconfiguration. For this purpose, a minor change in the channel record is introduced. The synchronization protocol is implemented using two bit vectors inside the channel records, one at the producer side and one at the consumer side. These bit vectors contain information about among others the read and write pointers, through which the channel fullness can be determined. One bit in this vector is designated as the reconfiguration bit, indicating that the task at the producer or consumer side is being reconfigured. This bit is set by the configuration task, upon receiving the acknowledge signal from the reconfigured task, and reset again when the task is restarted or resumed. When the task on the other side of the channel performs a Claim Data or Claim Space and it sees that there is no data/space in the channel, then it first inspects this bit before going idle. If it is raised, then Claim Data or Claim Space returns a special pointer, RECON EXCEPTION, indicating that the channel empty/fullness is caused by the task on the other side being reconfigured. Note that the checking of this reconfiguration bit is only done when the channel is found empty or full for efficiency reasons, and to allow as much of valid data in the channel as possible to be consumed. Although this leads to some overhead, it is recommended to always check for this pointer after each Claim Data or Claim Space, so that such exception conditions can be detected and the appropriate measures can be taken. It is not always guaranteed that such situations will never occur, especially if the producer and consumer tasks are designed by different people and one of them may exhibit some unexpected behaviour.

The original protocol was implemented in software, i.e. the channel information is kept central in memory and synchronization is done via reads and writes. For high-throughput applications, a hardware implementation is required. Currently, a VHDL implementation of a device shell is available which serves as an interface between a hardware device/(co-)processor and a system bus. This shell takes care of the synchronization protocol and has a generic communication interface to communicate with other devices. The signals of this interface can then be translated to the underlying communication infrastructure (e.g. bus, switch matrix) by a wrapper. The device itself may also have its own set of generic communication interfaces for autonomous reading or writing actions. Each device shell contains one or more (memory mapped) signalling registers for e.g. indicating data/space availability and one or more blocks for bookkeeping of the channel information. FIG. 3 shows how the device shell interfaces with the system bus and the hardware device. To stop or suspend a particular hardware device, a register to the device shell can be added. In this register the reconfiguration commands Task Stop, Task Restart, Task Suspend, and Task Resume can be written by the CPU. This extra signalling register is needed because it may not be over-written by synchronization signals, furthermore it can also wake up the device from a potentially sleeping state. If the device supports polling reconfiguration acknowledgements then an extra register can be used by the device to report its status (running/stopped/suspended) to the configuration task.

The CPU sends a request to the task that it wants to reconfigure. For software tasks, this request is sent via a set of message queues. If the configuration task chooses to wait for the acknowledge in the form of an interrupt, it goes into the blocked state. Awakening this task is done also using message queues. Note that since it is desired to keep the latency of the acknowledge as short as possible, the reconfigured software task is temporarily given the highest priority after issuing the reconfiguration command to minimize the number of context switches. The original priority is restored after the acknowledge has been received. The following functions can be called for dynamic network reconfiguration:

Called by the configuration task:

Task Start

Task Stop

Task Restart

Task Suspend

Task Resume

Task Destroy

Channel Create

Channel Destroy

Channel Reconfigure

Called by other tasks:

Task Check Reconfigure

Wait Restart

Wait Resume

Task Start starts execution of a task. One can pass up to four arguments to the task by passing a pointer referencing a data array.

Task Stop stops execution of a task. The second argument indicates in what form the CPU expects the acknowledge (INTERRUPT or POLL).

Task Restart restarts a stopped task. Possible new arguments can be passed.

Task Suspend suspends execution of a task. Again the acknowledge mode can be chosen.

Task Resume resumes a suspended task. Possible new parameters can be passed.

Task Destroy signals a stopped task to self-terminate, then removes its task record from memory. Also checks if no channels are connected to the task. Note that the task may actually terminate itself later than the removal of the task record. An acknowledge mechanism for this operation have not been implemented to avoid the communication overhead. However, after destroying the task record, the task is considered to be non-existent from the network point of view. When the process is actually terminated has no affect on the rest of the network since it has already been decoupled.

Task Check Reconfigure is called by the processing task to check whether it is reconfigured. This is the point at which a task can actually respond to a possible reconfiguration command issued by the configuration manager. The function returns STOP (task is stopped), SUSPEND (task is suspended) or CONTINUE (continue execution).

Wait Restart is called by the stopped task. This function first sends an acknowledge to the configuration task, and then stops the task until it is restarted. This function returns DESTROY if the task should self-terminate for task deletion.

Wait Resume is called by the suspended task, it will send an acknowledge and then go to sleep until it is resumed.

Channel Create creates a channel structure in memory with specified producer and consumer tasks, number of buffers, and channel mode flags.

Channel Destroy removes the channel from memory and updates the producer and consumer task records.

Channel Reconfigure reconfigures the channel. Possible changes are: producer task, consumer task, channel capacity and channel mode flags.

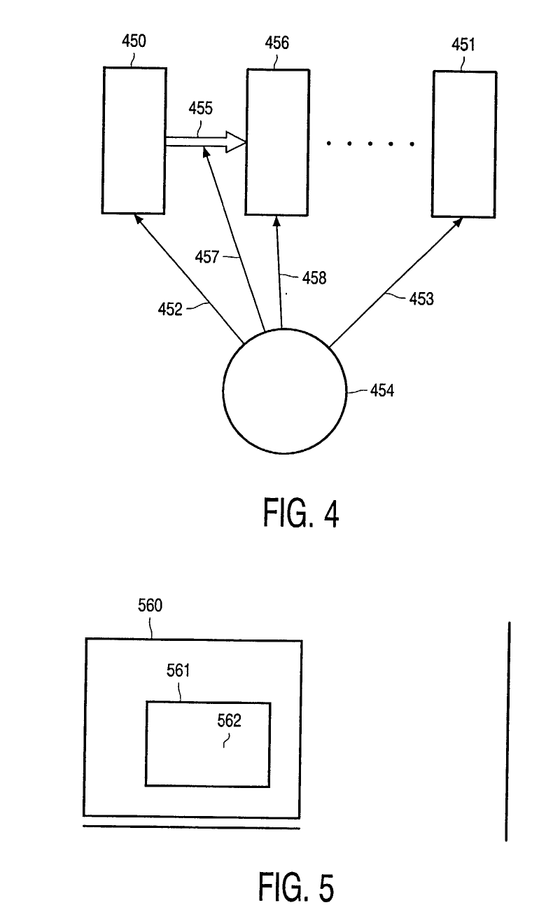

FIG. 4 illustrates a preferred embodiment of a re-configurable dynamic process network, which is also the best mode of the invention. 450 is a process. 456 is a process. 451 is a N-th process, where N≧1. 455 is one channel out of P channels, where P>0. 452 is a control. 458 is a control. 457 is a control. 453 is a M-th control, where M=N+P. 454 is a central task.

The illustration on FIG. 4 is a snapshot of the process network topology to the time t. Later the network topology may look differently. When the network is active, at least 1 process and at the most all N processes, where N≧1, are running. The processes are distributed on different coprocessors/computers to the extent relevant for the application. The processes are using FIFO channels to communicate in between. From zero channels and up to P channels, where P≧0 may be active. In order to avoid unnecessary latency and artefacts, reconfiguration points are spread out at strategic locations in all programs. Depending on the situation, the reconfiguration points used are either at iteration loop boundaries, at locations when trying to obtain a full buffer on an input channel, when trying to obtain an empty buffer on an output channel, or within the processing loop, all depending on what may seem relevant from a designer's point of view. The process network includes a central task managing the process network topology, and performing dynamic network reconfiguration. This includes removal and rerouting of channels, change of channel properties, and change of channel capacity. In addition, the central task is able to stop, suspend and remove tasks. The central task performs management/network reconfiguration based on various input sources. In example, the central task is able to perform network reconfiguration based on input from a task (e.g. error signals), resource management, or a user input. Under normal condition, the central task performs dynamic network reconfiguration while preserving the state, i.e. tasks are suspended rather than stopped while maintaining their state. In case of an emergency or a drastic change of functionality, the central task perform dynamic network reconfiguration with loss of state, i.e. tasks are completely stopped, and their internal state is thrown away.

FIG. 5 illustrates a preferred embodiment of the invention. 560 is a computing device like a personal computer. 561 is a memory area inside the computing device 560. 562 is a program residing inside the memory area 561.

The program 562 is an implementation of a dynamic process network reconfiguration algorithm according to the method of the invention, comprising streaming applications represented by process networks, in which tasks perform processing of data, and tasks communicate data to each other task through communication channels. The process network is dynamically reconfigurable, and a central task manages the process network topology. The program 562 resides in a memory area 561, which may be shared by one or more processors and co-processors, together forming the computer 560. Instead of a computer, a set-top box or a television set that comprises the memory 561 and the program 562 can for example be used too.

1. A method for dynamic process network reconfiguration, the process network (562) comprising a streaming application represented by a process network in which a first task (450) processes data and the first task (450) communicates data to a second task (456) through a communication channel (455), characterized in, that the process network is dynamically reconfigured, and a central task (454) manages a process network topology, and said central task (454) issues a command to manage the communication channel (455), and said central task (454) issues a command to manage at least one task of the first and second task (450, 451, 456), and the at least one of the first and second task (450, 451, 456) responds to said command only at a certain reconfiguration point (101, 102, 103, 104) in the at least one of the first and second task's processing loop.

2. A method for dynamic process network reconfiguration according to claim 1, characterized in, that said communication channel (455) is a FIFO channel.

3. A method for dynamic process network reconfiguration according to claim 1, characterized in, that said reconfiguration of the at least one task (450, 451, 456) is performed with loss of state, where said at least one task (450, 451, 456) is stopped, and the state of said at least one task is thrown away, and said at least one task is restarted later when needed.

4. A method for dynamic process network reconfiguration according to claim 1, characterized in, that said reconfiguration of the at least one task (450, 451, 456) is performed while preserving state, where said at least one task (450, 451, 456) is suspended while maintaining the state of the at least one task (450, 451, 456), and data are preserved within the channel (455), and said suspended task (450, 451, 456) is resumed afterwards when needed.

5. A method for dynamic process network reconfiguration according to claim 1, characterized in, that said command to manage the at least one task (450, 451, 456) from said central task (454) comprises the ability to stop, to suspend and to remove the at least one task (450, 451, 456).

6. A method for dynamic process network reconfiguration according to claim 1, characterized in, that said command to manage the channel (455) from said central task (454) comprises the ability to remove a channel (455), to redirect a channel (455), and to change a channel property.

7. A method for dynamic process network reconfiguration according to claim 1, characterized in, that said certain reconfiguration point (101) in the at least one task's processing loop is located at a boundarie of an iteration loop.

8. A method for dynamic process network reconfiguration according to claim 1, characterized in, that said certain reconfiguration point (102) in the at least one task's processing loop is located when trying to obtain a full buffer from an input channel.

9. A method for dynamic process network reconfiguration according to claim 1, characterized in, that said certain reconfiguration point (103) in the at least one task's processing loop is located when trying to obtain an empty buffer from an output channel.

10. An apparatus (560) with means (561) for dynamic process network reconfiguration, the process network (562) comprising a streaming application represented by a process network in which a first task (450) processes data and the first task (450) communicates data to a second task (456) through a communication channel (455), characterized in, that the process network is dynamically reconfigured, and a central task (454) manages a process network topology, and said central task (454) issues a command to manage the communication channel (455), and said central task (454) issues a command to manage at least one task of the first and second task (450, 451, 456), and the at least one of the first and second task (450, 451, 456) responds to said command only at a certain reconfiguration point (101, 102, 103, 104) in the at least one of the first and second task's processing loop.
